(19) United States
(12) Patent Application Publication
(10) Pub. No.: US 2013/0245825 A1
(43) Pub. Date: Sep. 19, 2013

(54) SAFETY DEVICE FOR THE SAFE USE OF INDUSTRIAL APPARATUSES AND ROBOTS, AND CONTROL METHOD FOR REALTIME VERIFICATION OF THE KINEMATIC STATE VALUES OF A ROBOTIZED APPARATUS

(71) Applicants: Federico Vicentini, Milano (IT); Nicola Pedrocchi, Iseo (IT); Matteo Malosio, Biassono (IT)

(72) Inventors: Federico Vicentini, Milano (IT); Nicola Pedrocchi, Iseo (IT); Matteo Malosio, Biassono (IT)

(73) Assignee: C.N.R. Consiglio Nazionale Ricerche, Roma (IT)

(21) Appl. No.: 13/876,354

(22) PCT Filed: Sep. 27, 2011
(86) PCT No.: PCT/IB2011/054246

§ 371 Date: May 21, 2013

(30) Foreign Application Priority Data
Sep. 28, 2010 (IT) MI2010A001767

(51) Int. Cl. B25J 9/16

(52) U.S. Cl. CPC B25J 9/1674; Y10S 901/09
USPC 700/253; 901/9

(57) ABSTRACT

A safety device (1) for the safe use of industrial apparatuses and robots, includes a movable structure (2), or robot, composed of rigid bodies (3) which are mutually articulated and provided with movers (4) for moving them with respect to each other, the movers (4) being managed by a control and management system (5) for the movement of the movable structure (2) according to a series of nominal kinematic state values. Inertial sensors (6) are applied to at least one of the rigid bodies (3) to make additional measurements of the kinematic state values of the movable structure (2) independently of the movers (4) and are functionally associated with at least one safety module (7) which is connected to the control and management system (5) to verify the congruity between the kinematic state values measured by the inertial sensors (6) and conditioned and integrated over time by a processing module (8) and an algorithm for integrating the inertial signal to estimate the spatial kinematic status of the rigid bodies (3) over time and the actual kinematic state values of the movable structure (2) measured by the control and management system (5). A processing module (8) for processing the signal originating from the inertial sensors (6) is functionally connected to the inertial sensor means (6) and is functionally connected to the safety module (7).

### TECHNICAL FIELD

The present invention relates to a robotized apparatus with an improved safety device and a control method for realtime verification of the kinematic state values of the robotized apparatus.

### BACKGROUND ART

In the field of automation, it is known to equip robotized apparatuses, such as for example industrial manipulators, with safety devices that are adapted to monitor the workspace of the moving apparatuses thus preventing potential conditions of risk for human operators deriving from the presence of the operators inside the workspace of the apparatuses. Moreover it is known to equip robotized apparatuses with redundant readings of the kinematic state values of the robotized apparatus so as to verify that it is operating according to the design directives. In fact a known approach in the industrial field is to duplicate redundant components and measurements for the purpose of increasing the reliability of the system.

In particular, kinematic state values are defined as the position, the speed and the acceleration in the operating space. These are calculated from the kinematic state values in space of the joints, i.e. in the system of reference relating to the joints of the rigid bodies and to the movement means defining the movable structure of the robotized apparatus. The values of the joints in space are measured, and optionally with a plurality of redundant measurements, by mechanical elements and sensors which are present in the movable structure.

It is mandatory for such conditions to be present in every machine for the purpose of operating under the design directives in a controlled manner through an adapted safety device.

From the viewpoint of the applicative context, according to reference standards such as, for example, the ISO 10218-2:2011 standard, the level of safety cannot be solely or partially ensured by the approval and validation steps of the operator who supervises the step of training and trajectory planning.

The introduction of regulations on sharing the workspace between robots and operators and on how motion is programmed, highlights the need to consider the operating conditions under which the in-line (run-time) generation of references for controlling the robot is allowed, with consequent continuous replanning of trajectories, for example in a solution in which it is necessary to eliminate collisions, and the manual guidance is allowed at operating speed by the user. The manual handling in shared space of industrial manipulators by operators and the in-line replanning at the rated speed (not limited to 250 mm/sec as in the old regulations) moreover introduces the need to monitor characteristic values of the movement of the manipulator which are compatible with the dynamics expressed by the machine and by the associated breakdowns that can arise under such conditions.

For example, within the safety conditions of the workspace of the robotized apparatuses and the possible presence of operators inside such space, safety devices are known which comprise a sensory unit, an electronic processor and a safety verification system.

With reference to US patent application 2005/0264251 A1 by KUKA ROBOTER GMBH, it is also known to simultaneously read signals relating to the kinematics of the robot from different sources, through inertial sensor means, for the purpose of verifying the congruity of such signals with reference values prerecorded and compared individually, i.e. precisely, each channel with the corresponding stored channel, independently of the kinematic value.

From the same patent application, it is moreover known to intervene through controlled shutdown operations and/or cutting the supply of power to the manipulator, when differences between operating and reference values exceed thresholds in given time windows.

In other words, in the cited patent application the accuracy of the signal originating from redundant sensors is verified using reference trajectories.

In this manner, the signal originating from such sensors is not “elaborated” or correlated to the kinematics of the robot, rather the data gathered from redundant sensors (accelerometers, video cameras etc.) are stored and simply compared with the current values during the re-tracing of the previously validated trajectories.

The approach to management and control disclosed in US 2005/0264251 A1 is not devoid of drawbacks, among which is the fact that run-time replanning, i.e. in real time, of the trajectories is not possible because reference trajectories are necessary which must be validated by the operator.

Consequently, this approach cannot be applied to operating scenarios in which the trajectory of the robot is calculated dynamically without the possibility of first being validated by the operator.

An alternative approach is constituted by a sensory unit, composed of one or more dynamic video cameras, which provides two-dimensional image data of the space to be monitored projected on each video camera, and the data are processed in order to provide a three-dimensional geometric reconstruction of the bodies present in the surveilled space.

In this manner it is possible to physically detect the objects and determine their exact position.

Such information is then overlaid over the geometric objects that define volumes to be protected configured in the system in order to establish whether, for example, the volume to be protected has been violated, i.e. whether an interpenetration between geometric objects is found.

More specifically, it is possible to set the zones of the workspace of the robotized apparatus to which access is prevented and the zones which trigger an alarm in the event of their being approached, as well as all the other parameters necessary for the operation of the safety vision system.

The danger zones are defined by three-dimensional virtual spaces that enclose the space that triggers an alarm and the space to be protected. Only objects that penetrate these areas are potentially in danger.

If the processing unit reports a violation of the space to be protected, the configurable outputs are deactivated.

In fact, the results of processing the images are sent from the processor to the safety system which with its inputs and outputs acts as an interface for controlling the machines and controls the entire operation of the safety device by acting on the electricity supply or on the supply of power to the electromechanical elements.

The sensory unit is accommodated above the workstation and subjects the entire field of action of the robotized apparatus to monitoring.

Such conventional safety devices just described are not devoid of drawbacks, including the fact that they are based solely on the position—in fact speed and acceleration are generally not calculated—of the objects contained within the control volumes derived from processing of the images, and that they are based on optical technology which, as such, is often unfavorable in terms of installation cost and, especially, operating conditions, which for example can be access limitations to the field of view, obstructions in the field of view, or known limitations to vision such as lighting conditions.

In fact, this type of safety device is based on the monitoring of a preset working volume by a plurality of video cameras in which the objects inside the working volume are identified through image processing techniques, for example stereoscopy, airborne time, or image analysis, and reported in a position inside the volume.

The safety characteristic is determined by the observance of conditions on geometries, for example virtual barriers, inside the working volume.

Violations of such conditions result in a controlled shutdown or a limited movement mode, as previously described.

Another example of a conventional safety device belonging to the class of solutions based on redundancy of measurement or installation of a component consists in an additional controller installed in the standard controller of the robotized apparatus.

The purpose of the additional controller consists in the high-level supervision of the motion of the robotized apparatus, actuating an emergency stop or setting inputs and outputs for the safety device.

More precisely, the supervision functions are activated by safety signal inputs, of which both the input signals and the output signals are connected to a PLC (Programmable Logic Controller) that is able to control the behavior of the robotized apparatus at different moments in time and in a Cartesian domain and to regulate the execution mode of the safety operations.

These last conventional safety devices, which partially solve the drawbacks and overcome the limitations of the safety devices described previously, are not devoid of drawbacks, including the fact that they perform safety operations on the basis of duplicate measurements made on the same sensory devices and especially the fact that they are not universally applicable to any kinematic chain, i.e. they do not provide a solution based on an additional device.

Moreover, it should be emphasized that in the safety devices described, the sources of errors that can influence the accuracy of the movement are linked to a wide range of factors.

More precisely, the ways in which errors can occur during the in-trajectory control of the robot can derive from errors in the position value returned by the encoders, errors made by the control system in generating the position references of the robot, errors in controlling the motors stemming from the position references and/or other errors in the data control and transmission sequence.

Such errors can arise owing to data transmission errors, or damage to one of the devices present in the chain of command, or calculation errors in the control algorithms, etc.

These and other sources of error typically cause a sudden movement, often characterized by high acceleration, that causes an “unexpected” movement of the robot from the ideal operating trajectory.

The errors are not typically characterized by a gradual shift or deviation of the position of the robot from the ideal, reference position.

This aspect makes it possible to identify and recognize an error in the execution of a determined trajectory within relatively short timescales.

### DISCLOSURE OF THE INVENTION

The aim of the present invention consists in providing a safety device that can be applied to a motorized apparatus and is capable of giving reliable verifications of the kinematic state values of the robotized apparatus, thus solving the drawbacks of the known art and intervening in total safety whenever anomalies occur either in the measurement of the kinematic state values or in the violation of previously defined work spaces, in compliance with the latest regulations on the safe use of industrial robots (ISO 10218-2:2011).

Within this aim, an object of the present invention consists in devising a control method for the realtime verification of the kinematic state values of the robotized apparatus that is simple and reliable.

Another object of the present invention is to provide an apparatus and a control method that are highly reliable, simple to implement and at low cost.

This aim and these and other objects which will become better apparent hereinafter are achieved by a safety device for the safe use of industrial apparatuses and robots, comprising a movable structure composed of rigid bodies which are mutually articulated and provided with movement means for moving them with respect to each other, said movement means being managed by control and management means for the movement of said movable structure according to a plurality of nominal kinematic state values, characterized in that it comprises inertial sensor means which are applied to at least one of said rigid bodies in order to make additional measurements of the kinematic state values of said movable structure independently of said movement means and are functionally associated with at least one safety module which is connected to said control and management means in order to verify the congruity between said kinematic state values measured by said inertial sensor means and conditioned and integrated over time by means of a processing module and an algorithm for integrating the inertial signal in order to estimate the spatial kinematic status of said rigid bodies over time and the actual kinematic state values of said movable structure measured by said control and management means, a processing module also being comprised for processing the signal originating from said inertial sensor means which is functionally connected to said inertial sensor means and is functionally connected to said safety module.

Moreover, the aim and the objects indicated above and others, which will become better apparent hereinafter, are achieved by a control method for the realtime verification of the kinematic state values of a robotized apparatus, comprising:
a first step of measuring the kinematic state values of a movable structure of a safety device by way of means for the control and management of movement means associated with said movable structure for the movement thereof according to a plurality of nominal kinematic state values,
   characterized in that it comprises:
a second step of measuring said kinematic state values by way of inertial sensor means which are applied to at least one rigid body that constitutes said movable structure, for the additional measurement of said kinematic state values independently of said movement means, by way of adapted signal processing algorithms,
a step of comparison between the kinematic state values measured by said control and management means and comparable kinematic values measured by said inertial sensor means,
halting the functional step of operation and activating the emergency step if the values measured by the two measurement systems show a difference that is greater than a maximum allowable error.

### BRIEF DESCRIPTION OF THE DRAWINGS

Further characteristics and advantages of the present invention will become better apparent from the description of a preferred, but not exclusive, embodiment of a robotized apparatus with an improved safety device and of a control method for realtime verification of the kinematic state values of a robotized apparatus, according to the invention, illustrated by way of non-limiting example, in the accompanying drawings, wherein:

FIG. 1 is a schematic side elevation view of an embodiment of a robotized apparatus with an improved safety device, according to the invention;

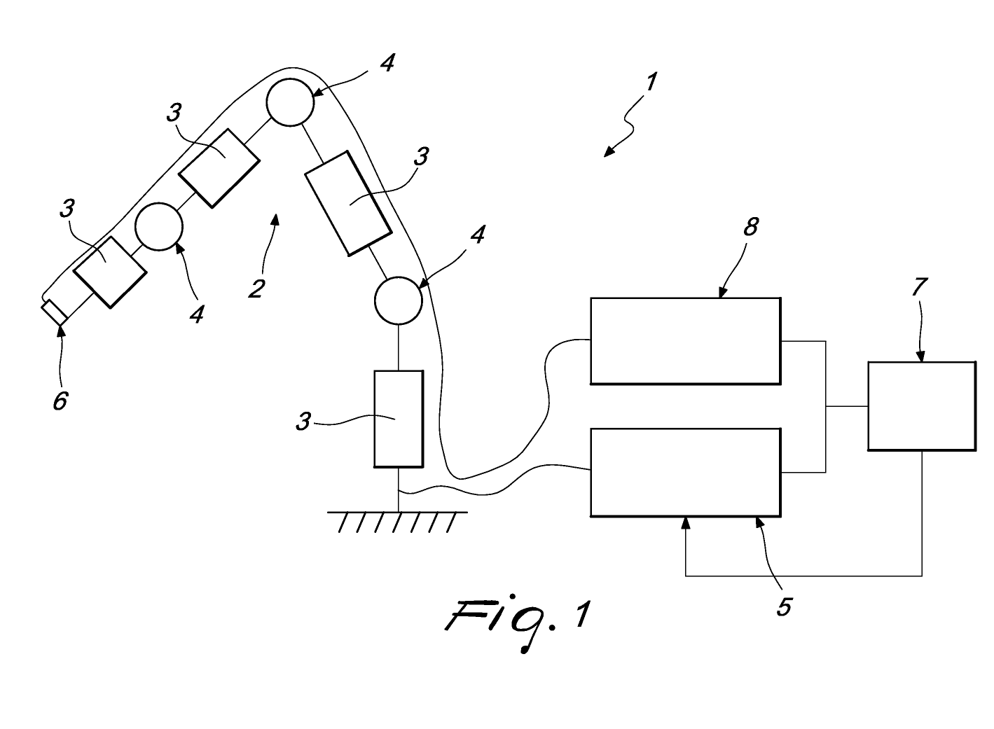

FIG. 2 is a block diagram of the robotized apparatus shown in FIG. 1;

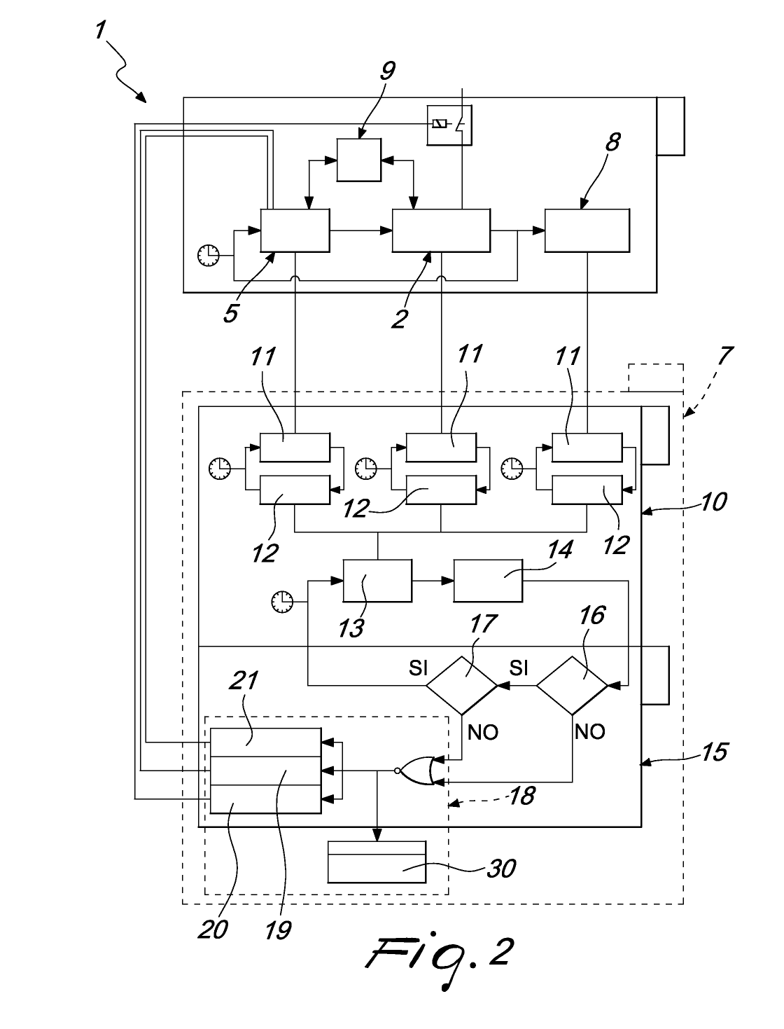

FIG. 3 is a block diagram of an embodiment of a control method for the realtime verification of the kinematic state values of a robotized apparatus, according to the invention.

### WAYS OF CARRYING OUT THE INVENTION

With reference to the figures, the safety device for using industrial apparatuses and robots, generally designated by the reference numeral 1, comprises a movable structure 2, which can be for example an industrial manipulator or the like and is composed of a set of rigid bodies 3 which are mutually articulated and provided with movement means 4, for example electric motors or pneumatic actuators, for their mutual movement.

More precisely, the movement means 4 are managed by control and management means 5 which make a plurality of measurements of the kinematic state values of the movable structure 2 such as position, speed and acceleration by means, for example, of encoders mounted on the joints of the kinematic chain of the movement means 4 so as to have the measurements from which to manage the movement of the movable structure 2 in order to reach a plurality of preset nominal kinematic state values, a typical function of actuation control systems.

According to the invention, the robotized apparatus 1 comprises inertial sensor means 6, constituted for example by conventional inertial sensor means, which are applied to at least one of the rigid bodies 3 of the movable structure 2 according to the point or points that it is desired to control.

The inertial sensor means 6 operate independently of the movement means 4 in order to make additional measurements of the kinematic state values of the movable structure 2 and are functionally associated with at least one safety module 7 that is functionally connected to the control and management means 5 in order to verify the congruity between the kinematic state values measured by the inertial sensor means 6 and conditioned and integrated over time by way of a processing module 8, which is functionally connected to the inertial sensor means 6 and to the safety module 7, and an algorithm for integrating the inertial signal in order to estimate the spatial kinematic status of the rigid bodies 3 over time and the kinematic state values of the movable structure 2 measured by the control and management means 5, i.e. relative to the joints of the movable structure 2.

The reason for using inertial sensor means 6 to detect the motion is the possibility of equipping generic robotized apparatuses 1 by applying the safety module 7 as a separate module, without intervening on the architecture of the robotized apparatus 1 proper.

In addition, as will be better described hereinafter, a module is provided for constraint conditions 9 that can be imposed by the user and it can be functionally connected to the control and management means 5 and to the movement means 4.

Advantageously, the safety module 7 comprises a module 10 for treatment of the data arriving from at least one among the processing module 8, the control and management means 5, and the movement means 4.

More specifically, the treatment module 10 is aimed at the acquisition of signals coming from several different sources within a robotized apparatus 1 equipped with inertial sensor means 6 for detecting motion so as to be capable of being used in a generic manner with respect to the nature of the sensors connected to the robotized apparatus 1. The signals, in fact, can be generated by different systems, in different times and with different procedures.

Specifically, at least two of said signals are necessarily available: the data for the joints of the movable structure 2 and the acquisition channels of the inertial sensor means 6.

Conveniently, the treatment module 10 comprises, for each data item to be treated, a data sampling module 11 and a cyclic data buffering module 12 which operate independently of each other and synchronously with each other with respect to a main cycle time.

Moreover, a block 13 is provided for reading each one of the cyclic data buffering modules 12 and a communications protocol block 14 is provided for assembling the data in output from each pair made up of a data sampling module 11 and a cyclic data buffering module 12.

In this manner, the information about the current state received from the movable structure 2 and from the inertial sensor means 6, as well as the information about the control parameters and the constraints, is all acquired by the treatment module 10 independently of the measurement source.

In particular, the data sampling module 11, which is associated with a time profile, makes it possible to assemble the data through the cyclic data buffering module 12 and to input them into the communications protocol block 14.

Advantageously, the safety module 7 comprises a module 15 for the validation and verification of the assembled data coming from the communications protocol block 14 and which is functionally connected to the treatment module 10.

In more detail, the validation and verification module 15 comprises a block 16 for the real time validation of the data originating from the communications protocol block 14 in order to identify any incongruities at the protocol encoding and transport level of the data.

As will be better described hereinafter, comprised within the validation block 16 is the correlation of the signals from the different data lines in relation to the nature of the inertial sensor used.

Moreover, the validation and verification module 15 comprises a block 17 for processing the data validated by the validation block 16 for the comparison of the kinematic state values measured by the inertial sensor means 6 with the kinematic state values of the movable structure 2 measured by the control and management means 5 or with the constraints entered by the user in the module for constraint conditions 9, for example, in order to verify whether the acceleration threshold on the joints of the movable structure 2 has been exceeded or a position that was previously associated with set safety conditions has been violated, i.e. a violation of the positioning conditions within the workspace governed by regulatory requirements associated with the presence of one or more human operators.

In addition to the processing block 17, which is functionally connected to the reading block 13, the validation and verification module 15 comprises a safety block 18 which is functionally connected to the control and management means 5 for the limitation and/or the interruption of the motion of the movement means 4 in the event of failure to verify the kinematic state values of the movable structure 2.

More specifically, the safety block 18 comprises a diagnosis unit 30 and at least one of an alert unit 19, a suspension unit 20 and a halting unit 21, all three of which are functionally connected to the processing block 17 and/or to the validation block 16 and to the control and management means 5, respectively, for the limitation of the motion of the movement means 4 and/or the generation of alert signals, for the controlled interruption of the motion of the movement means 4 without cutting the power, or for the controlled interruption of the motion of the movement means 4 with cutting the power and resetting.

The control method for realtime verification of the kinematic state values of a robotized apparatus, based on which the robotized apparatus 1 just described operates, is described hereinafter.

Generally, with reference to the nature of the signals and of the data used, the implementation of redundancy corresponds to the complete duplication of the signal sources. The data relating to such sources are therefore independent in that they originate from independent systems and are compared only in terms of current value.

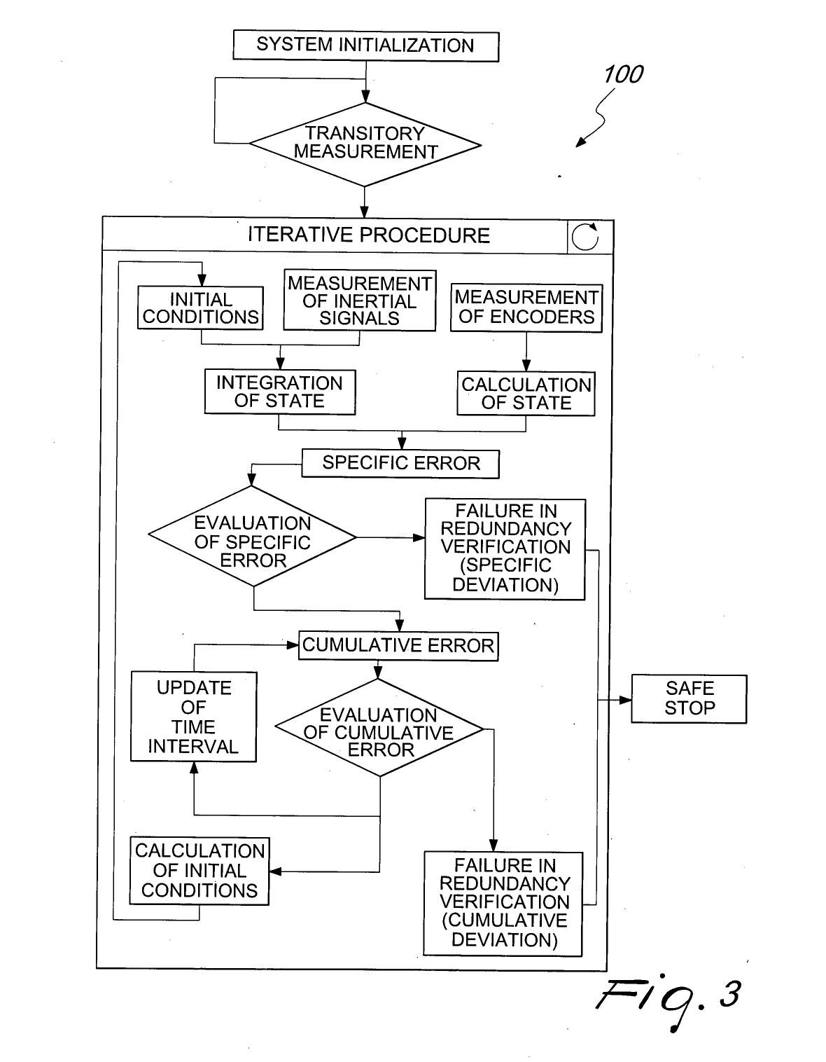

In the method according to the invention, generally designated in FIG. 3 by the reference numeral 100, there is, among the data originating from the two sources of signals, i.e. from the inertial sensor means 6 and from the control and management means 5, a correlation in that a procedure is performed of canceling out the error of drift owing to the numerical integral calculation of the kinematic state values read by the inertial sensor means 6 using the data obtained from the control and management means 5 as well, for example from encoders installed in the joints of the movable structure 2.

In particular, reconstruction of the position is performed, for example by means of conventional algorithms for inertial platforms, by numerically integrating the accelerations and angular speeds measured.

The integration is calculated iteratively using the state as of the previous step as the integration constant, in this way accumulating the error of integration or drift.

The accelerations and linear speeds also generically necessitate combined rotary and translational transformations between local reference systems, and thus information is generally used about the position and orientation, subjected to errors of drift.

An error canceling procedure involves an optimal estimate of the initial conditions, i.e. of the numeric integration constant, for each step of integration. Such estimate can be obtained from values at previous moment, assessed as reliable. The assessment is performed by taking account of the cumulative error over a time window of the most recent moments, such time window having a fixed width and a position that can move at each step of integration with respect to time.

More precisely, after a step of initializing the system, in which both the inertial sensor means 6 and the control and management means 5 are reset in order to prevent the new measurements from being influenced by measurements made previously, an initial transitory step is executed for the measurement of the actual kinematic state values, both with the inertial sensor means 6 and with the control and management means 5, for example by way of encoders, of the duration of at least one time window indicated for populating the cumulative error, originated from the set of instantaneous errors over time, over a sufficient set of moments in time.

Subsequently, a first step is provided of measuring the kinematic state values of the movable structure 2 by way of control and management means 5, i.e. by way of encoders.

According to the invention, simultaneously to the first step of measurement a second step of measurement is provided of the kinematic state values using the inertial sensor means 6.

Such second measurement step is provided with a system for processing the inertial signal, obtained from the inertial sensor means 6 for the calculation of the kinematic state of the movable bodies 2 by way of an integration operation using a system for integrating the inertial signal based on a movable window of integration and on an adapted number of samples for the integration.

With the measurement steps described above carried out, the method 100 involves a step of comparison between the kinematic state values measured by way of the control and management means 5 and comparable kinematic values measured by way of the inertial sensor means 6, with halting of the functional step of operation and activating of the emergency step if the values measured by the two measurement systems show a difference that is greater than a maximum allowable error.

More precisely, in this step of comparison the validation of the kinematic state occurs if the values obtained by way of the operation of integration of the inertial signal are found to differ by less than a maximum allowable error.

Subsequently, an iterative procedure is begun comprising the above mentioned comparison of the kinematic state values measured by the inertial sensor means 6 with the kinematic state values measured by the control and management means 5, reintegrating the initial conditions recalculated by the procedure and repeating the comparison for each successive calculation step.

In more detail, the method 100 considers the “moment by moment” verification of the position of the movable structure 2 or robot, as known from the control system by way of the signals coming from the position measurement systems on board the robot (for example encoders), by comparing it with the kinematic state (speed or position) obtained by conveniently integrating over time the acceleration signal, which is measured by way of adapted inertial sensor means 6 installed on board the robot.

The integration operation, which is double if calculating the position, inevitably leads to the introduction of an error of drift in the calculation of the kinematic state and of the position of the robot owing to the discretization of the signal coming from the accelerometer and from the sampling frequency with which such signal is continually integrated.

In principle therefore a continuous verification of the position cannot be effected without conveniently “zeroing” or “resetting” the error of drift present in the integrated position value.

In order to do this, the method exploits the “suddenness” with which errors occur during the motion of the manipulator and for which a maximum time period can be defined within which, with all probability, an error corresponding to the movement of the robot can be detected.

By considering a maximum acceptable error, which must take account of the possible error of drift of the integrated signal of the inertial sensor in the maximum time period considered, if such error is not exceeded at a time within a period of time equal to the maximum time period considered, then the verification of the kinematic values is satisfied.

Current calculation and inertial measurement technologies make it possible to suggest the maximum time period considered as being in the order of a few seconds for positioning errors of a few centimeters.

If this verification is satisfied, then at the subsequent moment of sampling, the value of the integration constant is considered to be the kinematic state (position) assumed at the moment after the moment that was previously used as the integration constant.

In other words, given “n” samples between moment “tᵢ” (initial moment) and “tᵢ₊ₙ” (current moment), once the condition is met of inclusion of the integral (double for the position) of the last “n” samples within the maximum acceptable error, then the positions at moments “tᵢ” and “tᵢ₊₁” are considered valid, and the position at moment “tᵢ₊₁” is considered as the basis for the integration of the inertial signal at the subsequent sampling moment, i.e. “tᵢ₊ₙ₊₁”.

In other words, a system for verifying the signal is provided in which the first two samples that constitute the window of integration are considered validated if the difference between the kinematic state values measured by way of the control and management means 5 and the inertial sensor means 6 is less than a maximum allowable error and the second, in time order, of these validated signals is taken as the new integration constant for the calculation of the kinematic state of the rigid bodies 3 at the subsequent moment, with the iterative procedure of integration of the inertial signal assuming as integration constant the value at the moment after the integration constant validated at the previous moment.

This approach is considered valid for dealing with the typical errors that can alter the movement of industrial robots, characterized by “suddenness” as described previously.

Note in particular that the validation of the states at moments tᵢ and tᵢ₊₁ occurs if the entire integrated signal, up to moment tᵢ₊ₙ, is affected by a maximum error which is less than a maximum allowable error.

In this manner, the iterative procedure provided by the method 100 verifies the correspondence, excepting a maximum deviation, of the current signals coming from the control and management means 5, i.e. from the encoders, and from the inertial sensor means, as previously explained.

If the verification is negative, specific large deviations are identified and the system is brought to a safe stop condition since there is no possibility of a correct calculation of the kinematic state values. If the verification is positive, verification of the cumulative error is performed. The extension of the time window for the cumulation of error is determined by the maximum permitted deviation, by the time interval of each integration step and by the time interval to be subjected to verification for cumulative errors. If the verification of the cumulative error is negative, then in fact a low dynamic deviation (slow variations over time) is read, and intercepted although the presence of specific positive verifications on the individual kinematic state values subjected to rapid variations over time. A safe stop is thus executed since the correspondence of the kinematic state values is not verified.

If the verification is positive, on the other hand, the reliability is assumed of the previous data of at least one time window previous to the current one. These data are used to process the initial conditions, i.e. the integration constants, for the subsequent step of integration.

In fact, the initial conditions are calculated based on a specific error evaluated on the basis of the instantaneous difference between the kinematic state values measured and the nominal kinematic state values and/or they are calculated based on a cumulative error evaluated on the basis of the cumulative differences over time between the actual kinematic state values and the nominal kinematic state values.

In terms of risk analysis associated with the definition of safety levels or standards, the use of correlated data in redundancy determines an increase in the risk factor. The procedure discussed above is considered useful to the determination of such risk factor and to the reduction thereof as a function of the procedure for evaluating the correlated error and corresponding zeroing of the inertial sensor means 6.

Moreover, the method 100 is suitable for manipulators and for other controlled kinematic chains not equipped with redundant systems for safety purposes, such as for example a double encoder for each joint of the movable structure 2. In this case the processing module 8 is represented by a third device with respect to the robotized apparatus 1.

Alternatively, the robotized apparatus 1 can be equipped with safety redundancies, therefore the processing module 8 coincides with the redundant signals. In this case too, the safety module 7 maintains all the described functionalities.

In practice it has been found that the robotized apparatus with an improved safety device and the control method for realtime verification of the kinematic state values of the robotized apparatus, according to the present invention, achieve the intended aim and objects in that they make it possible to constantly monitor the movements of a movable structure, such as a manipulator, by verifying that the kinematic state values measured by two separate and independent sources coincide except for an instantaneous error which is always under control.

Another advantage of the method, according to the present invention, consists in that if the nominal kinematic state values deviate excessively between the different sources of measurement and processing, the system includes forms of safety, according to the extent of the deviation, by alerting the user and/or stopping the movable structure on which it is operating.

The robotized apparatus with an improved safety device and the control method for realtime verification of the kinematic state values of the robotized apparatus, thus conceived, are susceptible of numerous modifications and variations, all of which are within the scope of the appended claims.

Moreover, all the details may be substituted by other, technically equivalent elements.

In practice the materials employed, provided they are compatible with the specific use, and the contingent dimensions and shapes, may be any according to requirements and to the state of the art.

The content of Italian patent application no. MI2010A001767, the priority of which is claimed in the present application, is incorporated as a reference.

Where the technical features mentioned in any claim are followed by reference numerals and/or signs, those reference numerals and/or signs have been included for the sole purpose of increasing the intelligibility of the claims and accordingly, such reference numerals and/or signs do not have any limiting effect on the interpretation of each element identified by way of example by such reference numerals and/or signs.

1. A safety device for safe use of industrial apparatuses and robots, comprising a movable structure including rigid bodies which are mutually articulated and provided with moving means for moving the rigid bodies with respect to each other, said moving means being managed by control and managing means for the movement of said movable structure according to a series of nominal kinematic state values, an inertial sensor which is applied to at least one of said rigid bodies to make additional measurements of the kinematic state values of said movable structure independently of said moving means and are functionally associated with at least one safety module which is connected to said control and managing means to verify congruity between said kinematic state values measured by said inertial sensor and conditioned and integrated over time by a processing module and an algorithm for integrating an inertial signal to estimate a spatial kinematic status of said rigid bodies over time and the actual kinematic state values of said movable structure measured by said control and managing means, the processing module processing the signal originating from said inertial sensor which is functionally connected to said inertial sensor and is functionally connected to said safety module.

2. The safety device according to claim 1, further comprising a module for constraint conditions that can be imposed by a user and can be functionally connected to said control and managing means and to said moving means.

3. The safety device according to claim 1, wherein said safety module comprises a module for treating data that arrive from at least one of said processing module, said control and managing means, and said moving means.

4. The safety device according to claim 3, wherein said treatment module comprises, for each data item to be treated, a data sampling module and a cyclic data buffering module, which operate mutually independently and synchronously with respect to a main cycle time.

5. The safety device according to claim 4, comprising a block for reading each one of said cyclic data buffering modules and a communications protocol block for assembling the data in output from each pair comprising said data sampling module and of said cyclic data buffering module.

6. The safety device according to claim 5, wherein said safety module comprises a module for the validation and verification of assembled data that arrive from said communications protocol block, said validation and verification module being functionally connected to said treatment module, said validation and verification module comprising a block for real-time validation of the data arriving from said communications protocol block to identify any incongruities in the data.

7. The safety device according to claim 6, wherein said validation and verification module comprises a block for processing the data validated by said validation block in order to compare said kinematic state values measured by said inertial sensor with said kinematic state values measured by said control and managing means or with the constraints entered by said user in said constraint condition module, said processing block being functionally connected to said reading block.

8. The safety device according to claim 6, wherein said validation and verification module comprises a safety block which is functionally connected to said control and managing means to limit and/or halt the motion of said moving means if said kinematic state values of said movable structure are not verified.

9. The safety device according to claim 8, wherein said safety block comprises at least one of an alert unit, a suspension unit and a halting unit, which are functionally connected to said processing block and/or to said validation block and to said control and managing means, respectively, to limit motion of said moving means and/or generate alert signals, for the controlled interruption of the motion of said moving means without cutting power or for controlled interruption of the motion of said moving means with cutting power and resetting.

10. A control method for realtime verification of kinematic state values of a robotized apparatus, comprising:
a first step of measuring the kinematic state values of a movable structure of a safety device by way of means for controlling and managing means associated with said movable structure for movement thereof according to a series of nominal kinematic state values,
a second step of measuring said kinematic state values by an inertial sensor which is applied to at least one rigid body of said movable structure, for additional measurement of said kinematic state values independently of said movement means,
a step of comparing between the kinematic state values measured by means for controlling and managing and comparable kinematic values measured by said inertial sensor means,
halting a functional step of operation and activating an emergency step if values measured by the two measurement systems show a difference that is greater than a maximum allowable error.

11. The method according to claim 10, wherein calculating the kinematic state of said rigid bodies by an integration operation is performed on the inertial signal obtained from said inertial sensor.

12. The method according to claim 10, wherein integrating the inertial signal is based on a movable window of integration and on a suitable number of samples for the integration.

13. The method according to claim 10, wherein verifying the signal in which the first two samples that comprise the window of integration are considered validated if the difference between said kinematic state values measured by said means for controlling and managing and said inertial sensor is less than a maximum allowable error and the second, in time order, of such validated signals is taken as a new integration constant for the calculation of the kinematic state of said rigid bodies at a subsequent moment.

14. The method according to claim 11, wherein said step of comparing comprises validating the kinematic state if the values obtained by way of the operation of integration of said inertial signal are found to differ by less than a maximum allowable error.

15. The method according to claim 14, comprising an iterative procedure of integration of the inertial signal which takes as an integration constant a value at a moment subsequent to the moment that was previously used as the integration constant and considered validated.
